(19) United States
(12) Patent Application Publication
(10) Pub. No.: US 2023/0201940 A1
(43) Pub. Date: Jun. 29, 2023

(54) WIRE ELECTRIC DISCHARGE MACHINE AND WIRE ELECTRIC DISCHARGE MACHINING METHOD

(71) Applicant: Sodick Co., Ltd., Kanagawa (JP)

(72) Inventors: KUNIHARU YAMADA, Kanagawa (JP); TOMOHITO HANAWA, Kanagawa (JP); YOSHIKI ENDO, Kanagawa (JP)

(73) Assignee: Sodick Co., Ltd., Kanagawa (JP)

(21) Appl. No.: 18/088,797

(22) Filed: Dec. 27, 2022

(30) Foreign Application Priority Data
Dec. 28, 2021 (JP) 2021-213595

(51) Int. Cl. B23H 7/20

(52) U.S. Cl. CPC B23H 7/20; B23H 2500/20

(57) ABSTRACT

The disclosure provides a wire electric discharge machine and a wire electric discharge machining method capable of detecting concentrated electric discharge in real time by a discharge position obtained from a preliminary discharge current, and calculating an accurate discharge position for use in measuring a plate thickness or the like. The wire electric discharge machine according to the disclosure includes a discharge position calculation circuit calculating a discharge position from the preliminary discharge current respectively detected through a current detector during a first period from a time when a waveform of the preliminary discharge current supplied to a machining gap, formed by a wire electrode and a workpiece, rises to a time when the preliminary discharge current reaches a constant current value, and a second period after the time when the preliminary discharge current reaches the constant current value to a time when a main discharge current is supplied.

### CROSS-REFERENCE TO RELATED APPLICATION

This application claims the priority benefits of Japanese application no. 2021-213595, filed on Dec. 28, 2021. The entirety of the above-mentioned patent application is hereby incorporated by reference herein and made a part of this specification.

### BACKGROUND

### Technical Field

The disclosure relates to a wire electric discharge machine and a wire electric discharge machining method for performing machining by intermittently supplying a voltage to a machining gap formed between a wire electrode and a workpiece.

### Description of Related Art

Electric discharge machining is an electrical machining method which arranges a wire electrode and a workpiece to face each other and repeatedly supplies a voltage pulse to a machining gap formed between the wire electrode and the workpiece to continuously generate electric discharge and perform machining with the discharge energy. A technology (USB10730126) is disclosed in which a conventional wire electric discharge machine has a main power supply circuit, an auxiliary power supply circuit, and a pulse generation circuit, and the switching elements of the main power supply circuit and the auxiliary power supply circuit are controlled to be turned on and off via the pulse generation circuit to apply a DC voltage to the machining gap to generate electric discharge. When electric discharge is generated between the wire electrode and the workpiece, at the part of the workpiece where the electric discharge is generated (discharge position), the material is blown away by the impact caused by the generation of electric discharge and then the temperature rises sharply due to the generation of heat, and the material of the workpiece locally melts and evaporates. The material removed from the workpiece cools and scatters as machining dust. Then, the supply of the voltage pulse is cut off after a predetermined time to terminate one shot of electric discharge, and a discharge mark having a size roughly proportional to the amount of the discharge current is formed on the surface of the workpiece.

It is known that the discharge energy not only is consumed for removing the material of the workpiece but also affects the electrode side and damages the electrode material, and this is called electrode consumption. The electrode consumption is an unavoidable phenomenon in electric discharge machining, and if the discharge positions are not sufficiently distributed and concentrated electric discharge occurs at approximately the same position, the wire electrode may break. Therefore, a technique for measuring the discharge position during machining and stopping the application of the voltage between electrodes when concentrated electric discharge occurs has been disclosed.

In Patent Literature 1 (Japanese Patent No. 5037941), the discharge position on the wire electrode is determined based on a preliminary discharge current, and the application of a main discharge voltage is stopped or the machining energy is calculated and the output is adjusted. Since the preliminary discharge current is a weak current and is easily affected by various external disturbances (for example, stray capacitance and stray inductance), the timing of detecting the discharge position is set to a time delayed by 150 ns to 300 ns from the initial stage of electric discharge.

However, when concentrated electric discharge is detected based on the discharge position obtained from the preliminary discharge current to stop the application of the main discharge voltage, it is desirable to detect the discharge position as early as possible after the electric discharge is started. This is because, in order to stop the main discharge in real time, after the preliminary discharge current flows between the electrodes, it is necessary to determine whether to stop the supply of the main discharge voltage pulse before applying the main discharge voltage pulse between the electrodes, and processing in a short time is required.

Further, calculation of the plate thickness or the like of the workpiece is performed by using the discharge position (Patent Literature 2, Japanese Patent No. 3085040). When calculating the plate thickness by the discharge position, unlike the case of detecting concentrated electric discharge, it is not necessary to detect the discharge position in a short time and it is desirable to perform the detection at a timing when the influence of the machining environment such as external disturbances is relatively small. This is because the use of an accurate discharge position increases the accuracy of plate thickness measurement.

### SUMMARY

The disclosure provides a wire electric discharge machine and a wire electric discharge machining method capable of detecting concentrated electric discharge in real time by a discharge position obtained from a preliminary discharge current, and calculating an accurate discharge position for use in measuring the plate thickness or the like.

A wire electric discharge machine according to the disclosure includes an auxiliary power supply circuit supplying a preliminary discharge current by applying a voltage for inducing generation of electric discharge to a machining gap formed by a wire electrode and a workpiece; a main power supply circuit supplying a main discharge current to the machining gap; a current detector detecting a discharge current flowing between the machining gap and a pair of conductors that are respectively provided above and below the workpiece and supply the discharge current to the wire electrode; and a discharge position calculation circuit calculating a discharge position respectively from the preliminary discharge current detected through the current detector during a first period from a time when a waveform of the preliminary discharge current supplied to the machining gap rises to a time when the preliminary discharge current reaches a constant current value, and a second period after the time when the preliminary discharge current reaches the constant current value to a time when the main discharge current is supplied. Further, the disclosure provides a wire electric discharge machining method, including supplying a preliminary discharge current by applying a voltage for inducing generation of electric discharge to a machining gap between a workpiece and a wire electrode, and then supplying a main discharge current to the machining gap, which is characterized in detecting a discharge position respectively from a current value of the preliminary discharge current during a first period from a time when a waveform of the preliminary discharge current supplied to the machining gap rises to a time when the preliminary discharge current reaches a constant current value, and a second period after the time when the preliminary discharge current reaches the constant current value to a time when the main discharge current is supplied.

Here, the “preliminary discharge current” is a current that flows to the machining gap due to application of the voltage from the auxiliary power supply circuit, and the “main discharge current” is a current that flows to the machining gap due to application of the voltage from the main power supply circuit. In addition, the “discharge current” is a general term for the preliminary discharge current and the main discharge current. The “discharge position” is a position of a discharge point on the wire electrode, and is synonymous with the discharge point. According to the disclosure, the discharge position is detected from the current value of the preliminary discharge current during the first period from the time when the waveform of the preliminary discharge current rises to the time when the preliminary discharge current reaches the constant current value, and the second period after the time when the preliminary discharge current reaches the constant current value to the time when the main discharge current is supplied. When the discharge position is detected in the first period, which is an early timing of the preliminary discharge current, the supply of the main discharge current can be stopped more quickly. Further, when the discharge position is detected in the second period when the influence of the machining environment such as external disturbances is small, the accurate discharge position can be used for calculating the plate thickness or the like. By detecting the discharge position in both the first period and the second period in this way, concentrated electric discharge can be detected and stopped in real time, and it becomes possible to effectively utilize the accurate discharge position for other calculations.

The current detector of the disclosure includes a sensor detecting the preliminary discharge current flowing through the machining gap due to application of the voltage of the auxiliary power supply circuit via an upper conductor, and a sensor detecting the preliminary discharge current flowing through the machining gap due to application of the voltage of the auxiliary power supply circuit via a lower conductor, and the discharge position calculation circuit of the disclosure acquires the preliminary discharge current from each of the sensors, calculates an integrated value of the preliminary discharge current to obtain each area, and obtains a ratio of the area to calculate the discharge position.

According to the disclosure, since the area is calculated from the integrated value of the preliminary discharge current and the discharge position is calculated from the area ratio, it is possible to reduce the influence of external disturbances due to the integral effect of addition.

According to the disclosure, the discharge position is calculated during the first period from the time when the waveform of the preliminary discharge current supplied to the machining gap rises to the time when the preliminary discharge current reaches the constant current value, and the second period after the time when the preliminary discharge current reaches the constant current value to the time when the main discharge current is supplied. Thus, the supply of the main discharge current can be stopped quickly and the plate thickness can be measured more accurately.

### BRIEF DESCRIPTION OF THE DRAWINGS

FIG. 1 is a block diagram showing the wire electric discharge machine 100 of the disclosure.

FIG. 2 is a circuit configuration diagram showing an example of the circuit of the machining power supply 1 in the wire electric discharge machine 100 of the disclosure.

FIG. 3 is a timing chart illustrating the normal operation of the wire electric discharge machine 100 of the disclosure.

FIG. 4 is a timing chart illustrating the operation of the wire electric discharge machine 100 of the disclosure when detecting concentrated electric discharge.

FIG. 5 is a timing chart illustrating the operation of the concentrated electric discharge detection circuit 431 of the wire electric discharge machine 100 of the disclosure.

FIG. 6 is a schematic diagram illustrating the operation of the concentrated electric discharge detection circuit 431 of the wire electric discharge machine 100 of the disclosure.

FIG. 7 is a schematic diagram illustrating the operation of the plate thickness calculation circuit 432 of the wire electric discharge machine 100 of the disclosure.

FIG. 8 is a schematic diagram illustrating the operation of the partial electric discharge detection circuit 433 of the wire electric discharge machine 100 of the disclosure.

FIG. 9 is a timing chart illustrating the operation of the wire electric discharge machine 100 of the disclosure when detecting partial electric discharge.

### DESCRIPTION OF THE EMBODIMENTS

### <1. Configuration of Wire Electric Discharge Machine 100>

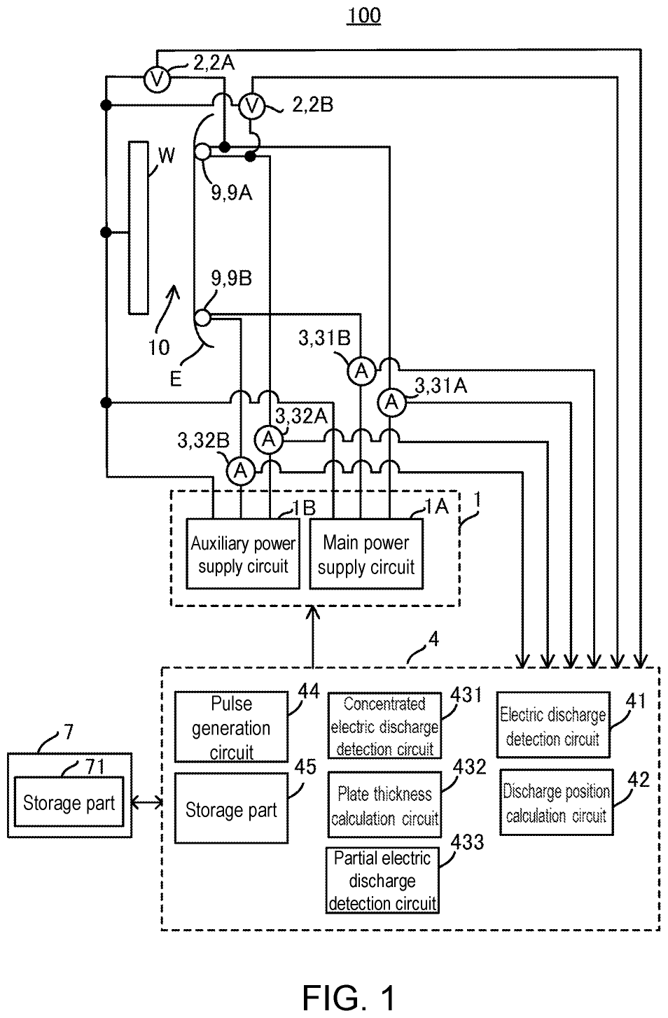

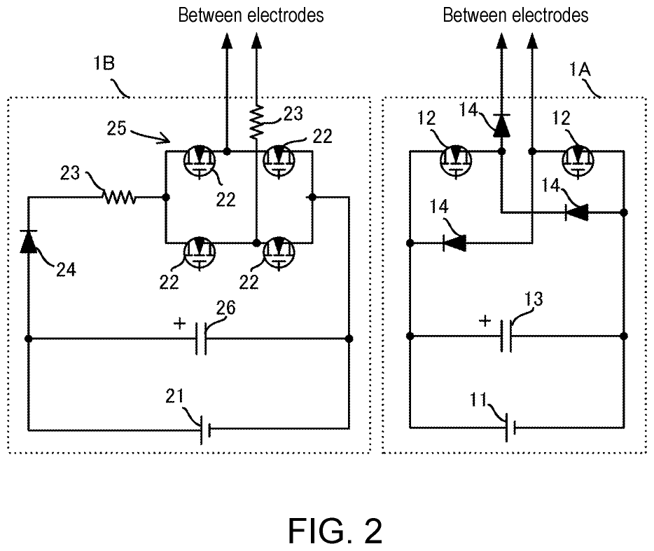

FIG. 1 is a block diagram showing a wire electric discharge machine 100 of the disclosure, and FIG. 2 is a circuit configuration diagram showing an example of the circuit of a machining power supply 1 in the wire electric discharge machine 100 of the disclosure. The wire electric discharge machine 100 is a device for moving an upper wire guide and a lower wire guide with respect to a workpiece W on the XY plane and repeatedly applying a predetermined machining voltage pulse to a machining gap 10 formed between a wire electrode E and the workpiece W to intermittently generate electric discharge, remove the material from the workpiece W with the discharge energy, and cut and machine the workpiece W into a desired shape. The wire electric discharge machine 100 includes the machining power supply 1, a voltage detector 2, a current detector 3, a determination circuit 4, a control device 7, a conductor 9, and the wire electrode E.

The machining power supply 1 is a power supply circuit for applying a voltage for generating electric discharge to the wire electrode E and the workpiece W, and includes a main power supply circuit 1A and an auxiliary power supply circuit 1B. In the wire electric discharge machine 100, electric discharge is generated by switching between the auxiliary power supply circuit 1B and the main power supply circuit 1A according to an instruction from a pulse generation circuit 44.

The main power supply circuit 1A is a power supply circuit that applies a voltage for supplying a main discharge current Ia for machining to the machining gap 10. When electric discharge is generated in the machining gap 10 and a preliminary discharge current Ib starts to flow, the main discharge current Ia is supplied by applying the voltage of the main power supply circuit 1A. The main power supply circuit 1A includes a DC power supply 11 provided in series with the machining gap 10 and outputting a DC voltage, one or more switching elements 12 provided in series between the machining gap 10 and the DC power supply 11, a capacitor 13, and a backflow blocking diode 14 inserted in series with the machining gap 10.

The switching element 12 is a type of field effect transistor (MOSFET) that excels in rising performance and withstand voltage performance. The capacitor 13 is a smoothing capacitor provided in parallel with the DC power supply 11 to prevent voltage fluctuations. The backflow blocking diode 14 prevents a backflow current caused by a back electromotive voltage generated in the machining gap 10 from flowing back to the DC power supply 11.

The auxiliary power supply circuit 1B is a power supply circuit that applies a voltage for inducing electric discharge in the machining gap 10, and the preliminary discharge current Ib is supplied to the machining gap 10 by applying the voltage of the auxiliary power supply circuit 1B. The auxiliary power supply circuit 1B includes a DC power supply 21 provided in series with the machining gap 10 and in parallel with the DC power supply 11 of the main power supply circuit 1A and outputting a DC voltage, one or more switching elements 22 provided in series between the machining gap 10 and the DC power supply 21, a current limiting resistor 23 provided in series with the switching elements 22 between the machining gap 10 and the DC power supply 21, a backflow blocking diode 24 provided in series with the DC power supply 21, a polarity switching circuit 25 that is a bridge circuit of a switching element provided between the DC power supply 21 and the switching elements 22, and a capacitor 26.

The switching element 22 has basically the same configuration as the switching element 12. The current limiting resistor 23 has a corresponding resistance value that sufficiently reduces the current value within a range in which the preliminary discharge current Ib that flows immediately after electric discharge is generated in the machining gap 10 is not interrupted. The backflow blocking diode 24 prevents a sudden current from flowing back to the auxiliary power supply circuit 1B including the DC power supply 21. The polarity switching circuit 25 selectively switches the polarity of the DC voltage output from the DC power supply 21. The capacitor 26 is a smoothing capacitor provided in parallel with the DC power supply 21 to prevent voltage fluctuations.

The voltage detector 2 is a sensor that detects the voltage between the electrodes of the wire electrode E and the workpiece W when there is no load and during electric discharge, and includes a main power supply voltage sensor 2A and an auxiliary power supply voltage sensor 2B. The main power supply voltage sensor 2A is provided between the main power supply circuit 1A and an upper conductor 9A, and detects the voltage between the electrodes due to the application of the voltage of the main power supply circuit 1A when there is no load and during electric discharge. Further, the auxiliary power supply voltage sensor 2B is provided between the auxiliary power supply circuit 1B and the upper conductor 9A, and detects the voltage between the electrodes due to the application of the voltage of the auxiliary power supply circuit 1B when there is no load and during electric discharge. The inter-electrode voltage value detected by the voltage detector 2 is provided to the determination circuit 4.

The current detector 3 is a current sensor that detects the current flowing between the electrodes, and includes a main power supply upper current sensor 31A, a main power supply lower current sensor 31B, an auxiliary power supply upper current sensor 32A, and an auxiliary power supply lower current sensor 32B. The main power supply upper current sensor 31A is a sensor that detects the current flowing between the wire electrode E and the workpiece W due to the application of the voltage of the main power supply circuit 1A via the upper conductor 9A. On the other hand, the main power supply lower current sensor 31B is a sensor that detects the current flowing between the wire electrode E and the workpiece W due to the application of the voltage of the main power supply circuit 1A via the lower conductor 9B. Further, the auxiliary power supply upper current sensor 32A is a sensor that detects the current flowing between the wire electrode E and the workpiece W due to the application of the voltage of the auxiliary power supply circuit 1B via the upper conductor 9A, and the auxiliary power supply lower current sensor 32B is a sensor that detects the current flowing between the wire electrode E and the workpiece W due to the application of the voltage of the auxiliary power supply circuit 1B via the lower conductor 9B. The current detector 3 is provided between the connection lines between the upper conductor 9A or the lower conductor 9B and the machining power supply 1. The current values detected by the current detector 3 are provided to the determination circuit 4, respectively.

The determination circuit 4 is a circuit that performs on/off control on the switching elements 12 and 22 of the machining power supply 1 and calculates the discharge position according to the inter-electrode voltage value provided from the voltage detector 2, the current value provided from the current detector 3, and the machining condition provided from the control device 7. Specifically, the determination circuit 4 includes an electric discharge detection circuit 41, a discharge position calculation circuit 42, a concentrated electric discharge detection circuit 431, a plate thickness calculation circuit 432, a partial electric discharge detection circuit 433, a pulse generation circuit 44, and a storage part 45.

The electric discharge detection circuit 41 is a circuit that outputs a discharge generation signal St indicating that electric discharge is generated in the machining gap 10 when the inter-electrode voltage of the machining gap 10 becomes equal to or less than the reference voltage Vr. Specifically, the electric discharge detection circuit 41 compares the inter-electrode voltage value obtained from the voltage detector 2 with the reference voltage Vr, and outputs the discharge generation signal St to the pulse generation circuit 44 and the discharge position calculation circuit 42 when the inter-electrode voltage value drops equal to or less than the reference voltage Vr. The reference voltage Vr is set to an appropriate value that can reliably detect with the minimum delay time that the preliminary discharge current Ib supplied from the auxiliary power supply circuit 1B starts to flow to the machining gap 10 and the inter-electrode voltage drops when electric discharge is generated. Data of the reference voltage Vr can be rewritten by the control device 7.

The discharge position calculation circuit 42 is a circuit that calculates the discharge position twice when receiving the discharge generation signal St from the electric discharge detection circuit 41. When the discharge generation signal St is input, the discharge position calculation circuit 42 acquires the current values from the auxiliary power supply upper current sensor 32A and the auxiliary power supply lower current sensor 32B, and calculates the discharge position twice during the rising period Tt (first period) and the steady period Ts (second period) of the preliminary discharge current Ib. The calculation is performed with the discharge position acquired during the rising period Tt of the preliminary discharge current Ib as the first discharge position H1ₙ (n=1, . . . , N; N is the total number), and the calculation is performed with the discharge position acquired during the steady period Ts of the preliminary discharge current Ib as the second discharge position H2ₘ (m=1, . . . , M; M is the total number). The first discharge position H1ₙ and the second discharge position H2ₘ are respectively stored in the storage part 45 in time series order, and the first discharge position H1ₙ is output to the concentrated electric discharge detection circuit 431 and the second discharge position H2ₘ is output to the partial electric discharge detection circuit 433.

The concentrated electric discharge detection circuit 431 is a circuit that detects whether concentrated electric discharge is being generated from the information of the first discharge position H1ₙ. The concentrated electric discharge detection circuit 431 outputs a concentrated electric discharge signal Ss having a short time width to the pulse generation circuit 44 when detecting that concentrated electric discharge is being generated.

The plate thickness calculation circuit 432 is a circuit that calculates the plate thickness L from the information of the second discharge position H2ₘ stored in the storage part 45 in time series.

The partial electric discharge detection circuit 433 is a circuit that estimates the shape of the machined surface of the workpiece W from the information of the first discharge position H1ₙ and the information of the second discharge position H2ₘ stored in the storage part 45 in time series, and determines that the electric discharge is partially biased. In wire electric discharge machining, if electric discharge is generated partially only in a part of the range, the straightness of the machined surface of the workpiece W is reduced, and the machining accuracy is reduced. For example, if electric discharge is concentrated in the center of the machined surface, the machined surface may have a drum shape that is recessed with respect to the edge, and if electric discharge is concentrated at the edge of the machined surface, the machined surface may have an inverted drum shape in which the center protrudes with respect to the edge. Therefore, when the partial electric discharge detection circuit 433 estimates the shape of the machined surface of the workpiece W and detects that electric discharge is partially biased, the partial electric discharge signal Sb having a short time width is output to the pulse generation circuit 44.

The pulse generation circuit 44 has a gate circuit that performs on/off control on the switching elements of the machining power supply 1 according to the discharge generation signal St from the electric discharge detection circuit 41, the concentrated electric discharge signal Ss from the concentrated electric discharge detection circuit 431, the partial electric discharge signal Sb from the partial electric discharge detection circuit 433, the inter-electrode voltage value provided from the voltage detector 2, the current value provided from the current detector 3, and the machining condition provided from the control device 7. Specifically, the pulse generation circuit 44 supplies a first gate signal to the switching element 12 of the main power supply circuit 1A, and supplies a second gate signal to the switching element 22 of the auxiliary power supply circuit 1B through the gate circuit. When the pulse generation circuit 44 outputs the first gate signal to the main power supply circuit 1A, the switching element 12 of the main power supply circuit 1A is turned on to supply the main discharge current Ia. Further, when the pulse generation circuit 44 outputs the second gate signal to the auxiliary power supply circuit 1B, the switching element 22 of the auxiliary power supply circuit 1B is turned on to supply the preliminary discharge current Ib.

Specifically, the pulse generation circuit 44 refers to the machining condition acquired from the control device 7, outputs the second gate signal to turn on the switching element 22, and applies the voltage of the DC power supply 21 of the auxiliary power supply circuit 1B to the machining gap 10 to induce electric discharge. The situation that electric discharge is generated and the preliminary discharge current Ib rises to the set peak current value is detected from the current value provided from the current detector 3, the output of the second gate signal is stopped to turn off the switching element 22, and the auxiliary power supply circuit 1B is cut off.

Further, when electric discharge is generated by the auxiliary power supply circuit 1B and the pulse generation circuit 44 receives the discharge generation signal St from the electric discharge detection circuit 41, the pulse generation circuit 44 outputs the first gate signal to turn on the switching element 12 to supply the main discharge current Ia. Then, when the first shot of main discharge current Ia rises to the set peak current value, the output of the first gate signal is stopped. After the discharge current pulse of the first shot of main discharge current Ia, the pulse generation circuit 44 inputs the current detection signal of the current detector 3, and turns the switching element 12 on/off at high speed at an on/off repetition frequency of 1 MHz or higher according to a preset discharge frequency until the main discharge current Ia attenuates and stops flowing to supply the main discharge current Ia, which is a high-frequency discharge current pulse, to the machining gap 10.

The storage part 45 is a memory that stores the first discharge position H1ₙ and the second discharge position H2ₘ, etc.

The control device 7 is a device that controls the overall operation of the wire electric discharge machine 100, and includes a storage part 71 therein. The control device 7 changes and sets the machining condition to adapt to the plate thickness Lₚ, if necessary, according to the data of the plate thickness Lₚ calculated by the plate thickness calculation circuit 432. Specifically, the machining condition suitable for the plate thickness Lₚ is retrieved and extracted from a combination of a plurality of machining conditions stored in the storage part 71. Then, the control device 7 outputs a pulse command signal corresponding to the machining condition to be changed to change and set the machining condition. The storage part 71 stores data of the machining conditions required for operation, specifically, a pause time (off time) Of, a repetition frequency (discharge frequency) Mo of electric discharge at a high frequency of 1 MHz or higher, a duration time (pulse width) Ma of the main discharge current Ia, an applied voltage (DC power supply voltage) Vo, a machining current (peak current value) Ip, a reference voltage Vr, a current reference value Ir, a delay time Ta, etc.

The conductor 9 is a member that contacts the wire electrode E to supply a current for electric discharge machining from the machining power supply 1, and the upper conductor 9A and the lower conductor 9B are provided vertically with the workpiece W sandwiched therebetween. The wire electric discharge machine 100 is provided with an upper guide assembly and a lower guide assembly. In the upper guide assembly provided on the upper side of the workpiece W, an upper wire guide, the upper conductor 9A, and a machining fluid jet nozzle are integrally incorporated in a housing. Further, in the lower guide assembly provided on the lower side of the workpiece W, a lower wire guide, the lower conductor 9B, and a machining fluid jet nozzle are integrally incorporated in a housing. A power supply terminal of the machining power supply 1 is connected to the upper conductor 9A and the lower conductor 9B, and supplies a current to the wire electrode E via the upper conductor 9A and the lower conductor 9B.

The wire electrode E is a wire-shaped electric discharge machining tool made of a conductive material. The wire electrode E is opposed to the workpiece W so that a machining gap is formed between the wire electrode E and the workpiece W, and is relatively moved in an arbitrary direction by a moving device with the workpiece W as a reference. The wire electrode E is inserted through the upper wire guide and the lower wire guide, and is stretched under tension between the upper wire guide and the lower wire guide. Further, the wire electrode E is connected to the power supply terminal of the machining power supply 1 via the upper conductor 9A and the lower conductor 9B. The workpiece W is also connected to the power supply terminal of the machining power supply 1 via an energized jig. When a predetermined voltage is applied between the electrodes of the wire electrode E and the workpiece W by the machining power supply 1, electric discharge is generated between the wire electrode E and the workpiece W, and electric discharge machining is performed.

### <2. Description of Discharge Position Calculation Circuit 42>

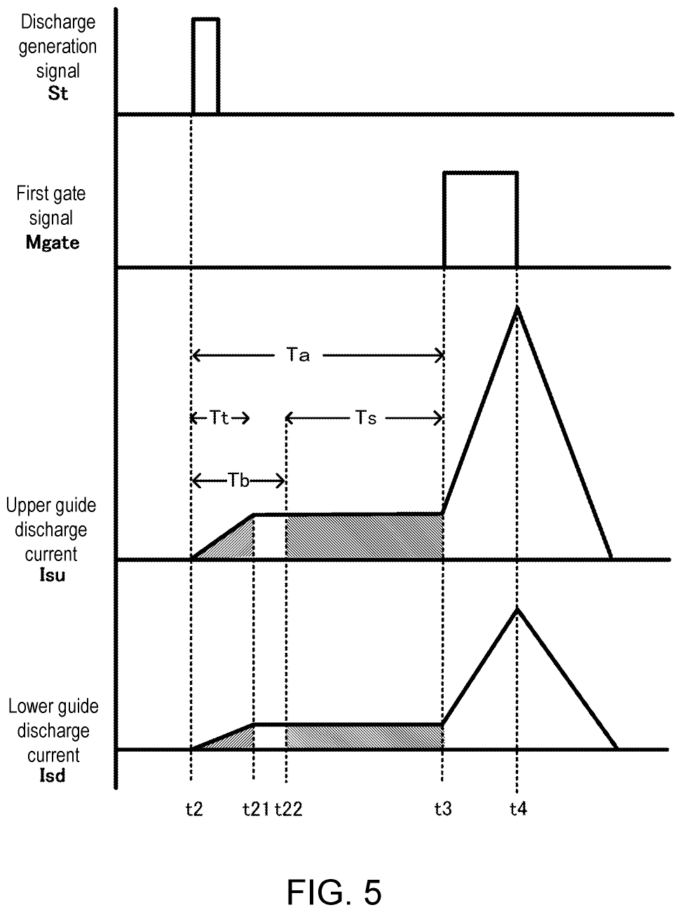

FIG. 5 is a timing chart illustrating the operation of the concentrated electric discharge detection circuit 431 of the wire electric discharge machine 100 of the disclosure. When the discharge generation signal St is input, the discharge position calculation circuit 42 calculates the discharge position twice during the rising period Tt and the steady period Ts of the preliminary discharge current Ib. In the wire electric discharge machine 100, the discharge current Is is supplied to the workpiece W via the discharge position on the wire electrode E from the upper and lower two locations of the upper conductor 9A and the lower conductor 9B. Therefore, it forms parallel circuits of a circuit in which the discharge current Is flows from the upper conductor 9A to the workpiece W via the discharge position, and a circuit in which the discharge current Is flows from the lower conductor 9B to the workpiece W via the discharge position. Since the wire electrode E is a resistor, the discharge position can be detected by detecting the current difference in the circuit generated according to the difference in the resistance ratio by the current detector 3. In the disclosure, time series data of the upper guide discharge current Isu and the lower guide discharge current Isd is acquired from the auxiliary power supply upper current sensor 32A and the auxiliary power supply lower current sensor 32B, the area is obtained by integrating the time series data over time, and the discharge position is calculated from the area ratio of the upper guide discharge current Isu and the lower guide discharge current Isd.

A specific method for calculating the first discharge position H1ₙ calculated in the rising period Tt is as follows. The time series data of the upper guide discharge current Isu from the auxiliary power supply upper current sensor 32A and the time series data of the lower guide discharge current Isd from the auxiliary power supply lower current sensor 32B from time t2 to time t21 are sequentially acquired, and to improve the detection accuracy, only a specific frequency band is extracted by passing them through a bandpass filter. Then, an integrated value Qsu of the upper guide discharge current Isu, which takes the rising period Tt as the time width, is obtained from the extracted time series data, and similarly, an integrated value Qsd of the lower guide discharge current Isd, which takes the rising period Tt as the time width, is obtained. The area ratio of the integrated value Qsu of the upper guide discharge current Isu and the integrated value Qsd of the lower guide discharge current Isd is obtained to calculate the first discharge position H1ₙ. Time t2, which is the start time of the rising period Tt, is the time when the discharge position calculation circuit 42 receives the discharge generation signal St. Time t21, which is the end time of the rising period Tt, is the time when the preliminary discharge current Ib starts to flow in the machining gap 10, gradually increases, and then stabilizes. This time t21 may be the time when the differential change of the preliminary discharge current Ib obtained by adding the upper guide discharge current Isu and the lower guide discharge current Isd is detected and the value of the differential change is within a specified range, or time t21 may be set by adding a predetermined time width to time t2. The calculated first discharge position H1ₙ is stored in the storage part 45 and output to the concentrated electric discharge detection circuit 431.

Similarly, a method for calculating the second discharge position H2ₘ calculated in the steady period Ts is as follows. The time series data of the upper guide discharge current Isu from the auxiliary power supply upper current sensor 32A and the time series data of the lower guide discharge current Isd from the auxiliary power supply lower current sensor 32B from time t22 to time t3 are sequentially acquired. Next, to improve the detection accuracy, noise is removed and only a specific frequency band is extracted by passing the time series data through a low-pass filter. Then, the integrated value Qsu of the upper guide discharge current Isu, which takes the steady period Ts as the time width, is obtained from the extracted time series data, and similarly, the integrated value Qsd of the lower guide discharge current Isd, which takes the steady period Ts as the time width, is obtained. The area ratio of the integrated value Qsu of the upper guide discharge current Isu and the integrated value Qsd of the lower guide discharge current Isd is obtained to calculate the second discharge position H2ₘ. Time t22, which is the start time of the steady period Ts, is the time when the rising period Tt ends and the preliminary discharge current Ib settles down to a constant value. This time t22 can also be set by adding a predetermined time width Tb to time t2, or may be set by detecting the time when the differential change of the preliminary discharge current Ib is detected and the value of the differential change settles down within a constant range. Further, time t3, which is the end time of the steady period Ts, is the time obtained by adding the delay time Ta to time t2. The calculated second discharge position H2ₘ is stored in the storage part 45 and output to the partial electric discharge detection circuit 433.

### <4. Description of Concentrated Electric Discharge Detection Circuit 431>

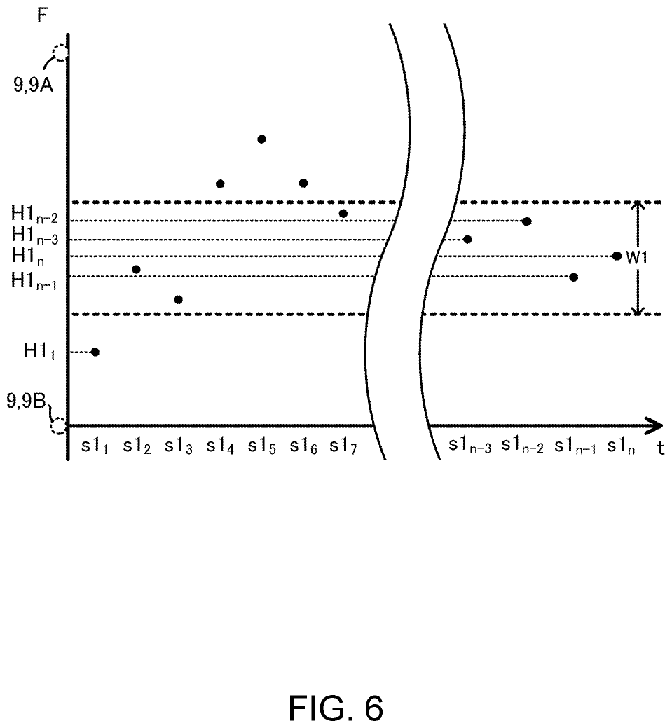

FIG. 6 is a schematic diagram illustrating the operation of the concentrated electric discharge detection circuit 431 of the wire electric discharge machine 100 of the disclosure. The concentrated electric discharge detection circuit 431 is a circuit that detects whether concentrated electric discharge is being generated from the information of the first discharge position H1ₙ. Specifically, it is assumed that the first discharge position H1ₙ₋₁ calculated after the start of machining is stored in the storage part 45 in time series order together with time s1ₙ₋₁. When the first discharge position H1ₙ is calculated at time sₙ, the concentrated electric discharge detection circuit 431 sets a constant width around the first discharge position H1ₙ as the concentrated electric discharge detection range W1. Here, the concentrated electric discharge detection range W1 is a range on the F axis of the wire electrode E when the wire electrode feeding direction F is taken as the F axis. The concentrated electric discharge detection circuit 431 goes back in time series from time sₙ and determines whether the data of the first discharge position H1ₙ₋₁ before time sₙ is continuously included in the concentrated electric discharge detection range W1 for a specified number P1. For example, if the specified number P1=3, the concentrated electric discharge detection circuit 431 goes back in time series from time sₙ and determines whether all the first discharge position H1ₙ₋₁ at time sₙ₋₁, the first discharge position H1ₙ₋₂ at time sₙ₋₂, and the first discharge position H1ₙ₋₃ at time sₙ₋₃ are included in the concentrated electric discharge detection range W1. If the concentrated electric discharge detection circuit 431 determines that all are included in the concentrated electric discharge detection range W1, as the result of determination, the concentrated electric discharge detection circuit 431 determines that concentrated electric discharge is being generated, and outputs the concentrated electric discharge signal Ss having a short time width to the pulse generation circuit 44. Here, the concentrated electric discharge detection range W1 is set wider than a small range width W2 used in the partial electric discharge detection circuit 433, which will be described later. This is because the first discharge position H1ₙ is acquired in the rising period Tt and thus is easily affected by external disturbances, and it is configured with a width for determination of concentrated electric discharge generation.

### <5. Description of Plate Thickness Calculation Circuit 432>

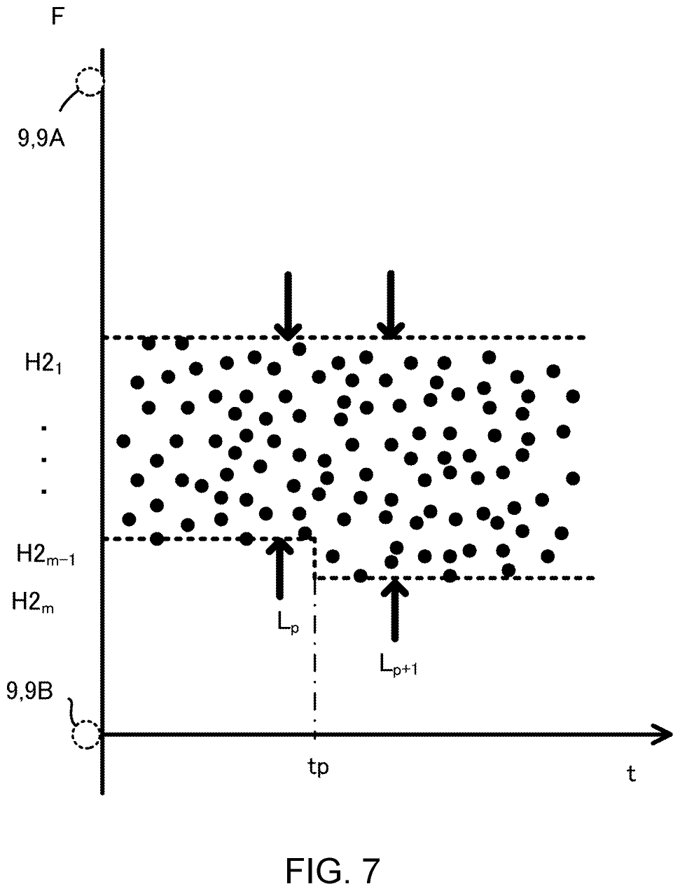

FIG. 7 is a schematic diagram illustrating the operation of the plate thickness calculation circuit 432 of the wire electric discharge machine 100 of the disclosure. The plate thickness calculation circuit 432 is a circuit that calculates the plate thickness Lₚ (p=1, . . . , P; P is the total number of plate thicknesses) of the workpiece W from the information of the second discharge position H2ₘ stored in the storage part 45 in time series. Specifically, the plate thickness calculation circuit 432 calculates the distribution of the second discharge position H2ₘ in the F axis direction from the data of the second discharge position H2ₘ stored in time series, and calculates the plate thickness Lₚ from the upper limit position and the lower limit position of the second discharge position H2ₘ in the F axis direction. The plate thickness calculation circuit 432 calculates the plate thickness Lₚ each time the second discharge position H2ₘ is calculated by the discharge position calculation circuit 42, and outputs the plate thickness Lₚ to the control device 7.

### <6. Description of Partial Electric Discharge Detection Circuit 433>

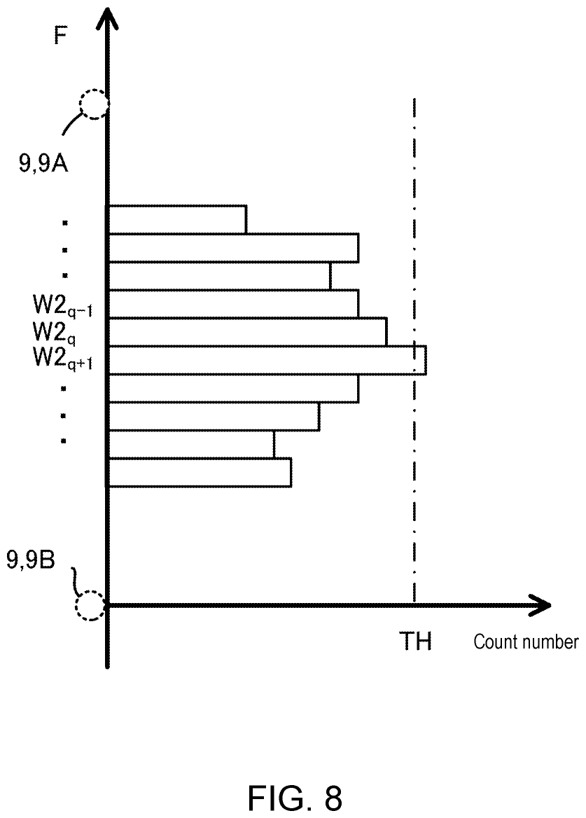

FIG. 8 is a schematic diagram illustrating the operation of the partial electric discharge detection circuit 433 of the wire electric discharge machine 100 of the disclosure. The partial electric discharge detection circuit 433 estimates the shape of the machined surface of the workpiece W from the information of the second discharge position H2ₘ stored in the storage part 45 in time series order. Specifically, the storage part 45 stores the second discharge position H2ₘ calculated after the start of machining in time series order. The partial electric discharge detection circuit 433 divides the range from the position in contact with the upper conductor 9A of the wire electrode E on the F axis to the position in contact with the lower conductor 9B into the small range width W2. Here, the small ranges divided into the small range width W2 are W2₁, W2₂, . . . , W2_{q}, . . . , W2_{Q} (q=1, 2, . . . , Q; Q is the number of divisions) in order from the position in contact with the upper conductor 9A. The partial electric discharge detection circuit 433 counts the number (count number) of data of the second discharge position H2ₘ included in the small range W2_{q} each time the second discharge position H2ₘ is calculated after the start of machining, and further calculates whether the count number of the second discharge position H2ₘ included in the small range W2_{q} is equal to or greater than a predetermined threshold value TH. Then, the small range W2_{q}, the count number, and information indicating that the count number is equal to or greater than the threshold value TH are stored as a set in the storage part 45.

When the second discharge position H2ₘ₊₁ is calculated at time s2ₘ₊₁ and output from the discharge position calculation circuit 42, the partial electric discharge detection circuit 433 detects the small range W2_{q} including the second discharge position H2ₘ₊₁ and counts the number (count number) of data. Then, if the count number of the small range W2_{q} including the second discharge position H2ₘ₊₁ is equal to or greater than the threshold value TH, the partial electric discharge detection circuit 433 determines that the electric discharge is partially biased, and outputs the partial electric discharge signal Sb having a short time width to the pulse generation circuit 44. Here, the first discharge position H1ₙ₊₁ may be output from the discharge position calculation circuit 42 to the partial electric discharge detection circuit 433, and the partial electric discharge signal Sb may be output according to the information of the first discharge position H1ₙ₊₁. Specifically, when the partial electric discharge detection circuit 433 receives the first discharge position H1ₙ₊₁, the partial electric discharge detection circuit 433 may detect the small range W2_{q} including the first discharge position H1ₙ₊₁, and when the count number of the small range W2_{q} including the first discharge position H1ₙ₊₁ is equal to or greater than the threshold value TH, the partial electric discharge detection circuit 433 may determine that the electric discharge is partially biased, and output the partial electric discharge signal Sb having a short time width to the pulse generation circuit 44. In this way, it is possible to stop the supply of the discharge current Is more quickly.

Here, the small range width W2 used in the partial electric discharge detection circuit 433 is set narrower than the concentrated electric discharge detection range W1 used in the concentrated electric discharge detection circuit 431. This is because the second discharge position H2ₘ is acquired in the steady period Ts so the influence of external disturbances is suppressed, and the discharge position is calculated more accurately than the first discharge position H1ₙ.

<7. Description of Normal Operation of Wire Electric Discharge Machine 100 and Operation when Detecting Concentrated Electric Discharge>

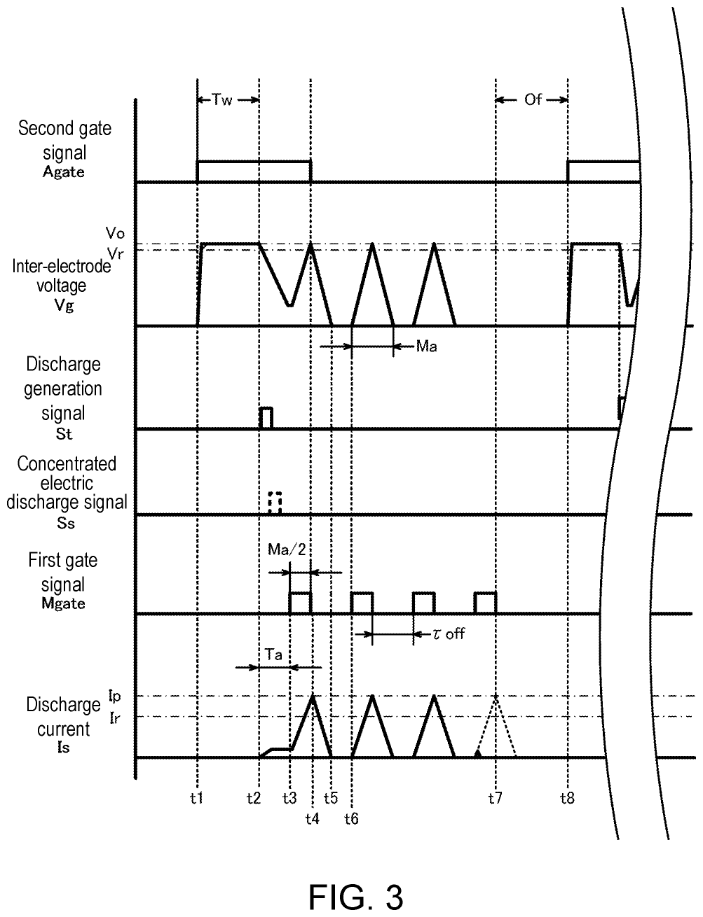

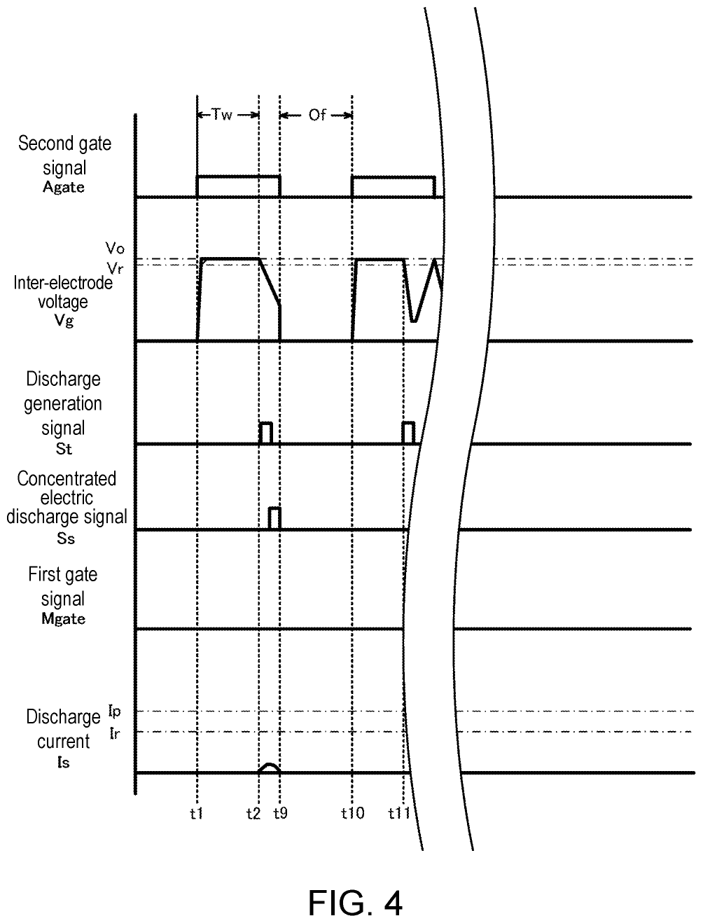

FIG. 3 is a timing chart illustrating the normal operation of the wire electric discharge machine 100 of the disclosure. FIG. 4 is a timing chart illustrating the operation of the wire electric discharge machine 100 of the disclosure when detecting concentrated electric discharge. In the figure, Agate is the waveform of the second gate signal, Vg is the waveform of the inter-electrode voltage of the machining gap 10, St is the waveform of the discharge generation signal, Mgate is the waveform of the first gate signal, and Is is the waveform of the discharge current of the machining gap 10.

The operator inputs and sets data of an arbitrary machining condition to the control device 7 in advance. The data of the machining condition is stored in the storage part 71 of the control device 7. The data of the machining condition stored in the storage part 71 or a switching signal based on the machining condition is output to the pulse generation circuit 44 when machining is performed. The data of the machining condition required for the operation of the machining power supply device of the embodiment includes, for example, the pause time (off time) Of, the repetition frequency (discharge frequency) Mo of electric discharge at a high frequency of 1 MHz or higher, the duration time (pulse width) Ma of the main discharge current Ia, the applied voltage (DC power supply voltage) Vo, the machining current (peak current value) Ip, the reference voltage Vr, the current reference value Ir for determining whether the discharge current is flowing, and the delay time Ta.

The control device 7 outputs the data of each machining condition such as the off time Of, the discharge frequency Mo, and the pulse width Ma to the pulse generation circuit 44, and the pulse generation circuit 44 sets data of each machining condition in a setting circuit. Further, the control device 7 outputs a switching signal based on the applied voltage Vo to the variable DC power supply 11 to set the DC power supply voltage to the applied voltage Vo, and outputs data of the reference voltage Vr for detecting the generation of electric discharge to the voltage detector 2. In addition, if data of a new plate thickness Lₚ is input from the plate thickness calculation circuit 432, the control device 7 changes and sets the machining condition suitable for the input plate thickness Lₚ, and outputs data of the newly changed and set machining condition to the pulse generation circuit 44.

The pulse generation circuit 44 measures the off time Of of the machining condition set in the setting circuit during machining. At time t1 when the set off time Of elapses, the pulse generation circuit 44 outputs the second gate signal Agate. The second gate signal Agate output from the pulse generation circuit 44 is supplied to the gate of the switching element 22 of the auxiliary power supply circuit 1B. As a result, the switching element 22 is turned on, and a DC voltage for inducing electric discharge is applied to the machining gap 10 from the DC power supply 21 of the auxiliary power supply circuit 1B.

At the point of time t1, the preliminary discharge current Ib (Is) does not flow through the machining gap 10. Then, when electric discharge is generated in the machining gap 10 at time t2, which comes after an unspecified discharge waiting time Tw from time t1, the preliminary discharge current Ib (Is) starts to flow through the machining gap 10, and the inter-electrode voltage Vg drops sharply. At this time, the preliminary discharge current Ib (Is) gradually increases. When the inter-electrode voltage Vg drops, the inter-electrode voltage Vg becomes equal to or less than the reference voltage Vr. As a result, the discharge generation signal St having a short time width is output from the voltage detector 2 to the pulse generation circuit 44 and the discharge position calculation circuit 42.

When the discharge generation signal St is input, the discharge position calculation circuit 42 acquires the current values from the auxiliary power supply upper current sensor 32A and the auxiliary power supply lower current sensor 32B, and calculates the discharge position twice in the rising period Tt and the steady period Ts of the preliminary discharge current Ib. The first discharge position H1ₙ, which is the discharge position during the rising period Tt, and the second discharge position H2ₘ during the steady period Ts calculated by the discharge position calculation circuit 42 are stored in the storage part 45, and the first discharge position H1ₙ is output to the concentrated electric discharge detection circuit 431 and the second discharge position H2ₘ is output to the partial electric discharge detection circuit 433.

The plate thickness calculation circuit 432 calculates the plate thickness Lₚ of the workpiece W from the information of the second discharge position H2ₘ stored in the storage part 45 in time series order, and outputs the data of the plate thickness Lₚ to the control device 7.

The partial electric discharge detection circuit 433 determines whether the electric discharge is partially biased from the information of the second discharge position H2ₘ, and outputs the partial electric discharge signal Sb having a short time width to the pulse generation circuit 44 when the electric discharge is partially biased. The operation when detecting partial electric discharge will be described later.

The concentrated electric discharge detection circuit 431 determines concentrated electric discharge from the information of the first discharge position H1ₙ, and outputs the concentrated electric discharge signal Ss having a short time width to the pulse generation circuit 44 when detecting that concentrated electric discharge is being generated.

When the discharge generation signal St is input from the voltage detector 2, the pulse generation circuit 44 outputs the first gate signal Mgate at time t3, which comes after the delay time Ta from time t2. Then, the switching element 12 of the main power supply circuit 1A is turned on, and a large main discharge current Ia is supplied to the machining gap 10 from the main power supply circuit 1A. At this time, since the second gate signal Agate is still output, the voltage of the DC power supply 11 of the main power supply circuit 1A is superimposed, and the discharge current Is, which is the sum of the preliminary discharge current Ib and the main discharge current Ia, rises sharply to the set peak current value Ip. On the other hand, when the pulse generation circuit 44 receives the concentrated electric discharge signal Ss from the concentrated electric discharge detection circuit 431 between time t2 and time t3, the output of the second gate signal Agate is stopped without outputting the first gate signal Mgate (FIG. 4). As a result, both the switching element 12 of the main power supply circuit 1A and the switching element 22 of the auxiliary power supply circuit 1B become non-conductive, the inter-electrode voltage Vg drops rapidly, the discharge current Is (preliminary discharge current Ib) drops sharply, and the arc is extinguished. In this case, at time t9 when the discharge current Is stops flowing, the pulse generation circuit 44 starts measuring the off time Of of the set machining condition. Then, at time t10 after the off time Of has elapsed, the second gate signal Agate is output again to turn on the switching element 22 of the auxiliary power supply circuit 1B, thereby starting the next electric discharge (FIG. 4).

If the pulse generation circuit 44 does not receive the concentrated electric discharge signal Ss from the concentrated electric discharge detection circuit 431 between time t2 and time t3 (FIG. 3), after the first gate signal Mgate is output, the output of the first gate signal Mgate and the second gate signal Agate is stopped at time t4 after a predetermined time according to the preset pulse width Ma. Therefore, at time t4, both the switching element 12 of the main power supply circuit 1A and the switching element 22 of the auxiliary power supply circuit 1B become non-conductive. As a result, the inter-electrode voltage Vg drops rapidly, the discharge current Is drops sharply from the set peak current value Ip, and the arc is extinguished at time t5.

After the pulse generation circuit 44 supplies the first shot of discharge current Is after the generation of electric discharge, the pulse generation circuit 44 outputs the first gate signal Mgate so that the switching element 12 is repeatedly turned on/off at a high frequency of 1 MHz or higher according to the set discharge frequency Mo and pulse width Ma (FIG. 3). Accordingly, after stopping the output of the first gate signal Mgate, the pulse generation circuit 44 outputs the first gate signal Mgate again at time t6 after the pause width τoff determined by the discharge frequency Mo and the pulse width Ma. While the discharge current Is (main discharge current Ia) continues to flow in the main power supply circuit 1A, the first gate signal Mgate is output at a predetermined high frequency according to the set discharge frequency Mo, the switching element 12 of the main power supply circuit 1A is repeatedly turned on/off at high speed, and the discharge current Is is supplied.

At time t7 when the discharge current Is attenuates over time and drops below the current reference value Ir and stops flowing, the pulse generation circuit 44 stops the output of the first gate signal Mgate to turn off the switching element 12, and starts measuring the off time Of of the set machining condition. Then, at time t8 after the off time Of has elapsed, the second gate signal Agate is output again to turn on the switching element 22 of the auxiliary power supply circuit 1B, thereby starting the next electric discharge.

<8. Description of Operation of Wire Electric Discharge Machine 100 when Detecting Partial Electric Discharge>

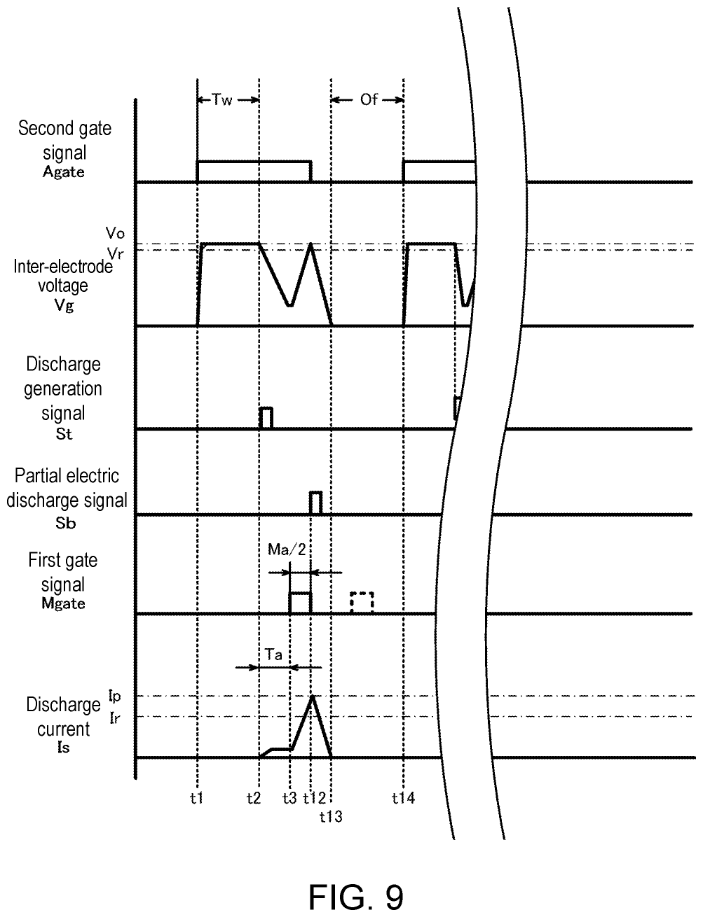

FIG. 9 is a timing chart illustrating the operation of the wire electric discharge machine 100 of the disclosure when detecting partial electric discharge. The pulse generation circuit 44 outputs the second gate signal Agate at time t1, and when the DC voltage for inducing electric discharge is applied to the machining gap 10 from the DC power supply 21 of the auxiliary power supply circuit 1B, electric discharge is generated in the machining gap 10 at time t2. Then, the preliminary discharge current Ib gradually increases in the machining gap 10, and the inter-electrode voltage Vg drops sharply. Due to the drop of the inter-electrode voltage Vg, the discharge generation signal St is output from the voltage detector 2 to the pulse generation circuit 44 and the discharge position calculation circuit 42.

When the discharge generation signal St is input from the voltage detector 2, the pulse generation circuit 44 outputs the first gate signal Mgate at time t3, and the main discharge current Ia is supplied to the machining gap 10 from the main power supply circuit 1A. The discharge current Is, which is the sum of the preliminary discharge current Ib and the main discharge current Ia, rises sharply to the set peak current value Ip.

When the discharge generation signal St is input, the discharge position calculation circuit 42 acquires the current values from the auxiliary power supply upper current sensor 32A and the auxiliary power supply lower current sensor 32B, and calculates the discharge position twice in the rising period Tt and the steady period Ts of the preliminary discharge current Ib. The second discharge position H2ₘ, which is the discharge position during the steady period Ts calculated by the discharge position calculation circuit 42, is stored in the storage part 45 and output to the partial electric discharge detection circuit 433.

The partial electric discharge detection circuit 433 counts the number of data of the second discharge position H2ₘ included in the small range W2_{q} for each small range W2_{q} after the start of machining from the information of the second discharge position H2ₘ₋₁ stored in the storage part 45. Further, the partial electric discharge detection circuit 433 calculates the small range W2_{q} including the second discharge position H2ₘ output from the discharge position calculation circuit 42, and outputs the partial electric discharge signal Sb to the pulse generation circuit 44 when the count number of the small range W2_{q} is equal to or greater than the threshold value TH (FIG. 9).

When performing the normal operation, after supplying the first shot of discharge current Is after the generation of electric discharge, the pulse generation circuit 44 outputs the first gate signal Mgate so that the switching element 12 is repeatedly turned on/off at a high frequency of 1 MHz or higher according to the set discharge frequency Mo and pulse width Ma. However, when receiving the partial electric discharge signal Sb from the partial electric discharge detection circuit 433 at time t12, the pulse generation circuit 44 stops the output of the first gate signal Mgate after the time of reception (FIG. 9). As a result, both the switching element 12 of the main power supply circuit 1A and the switching element 22 of the auxiliary power supply circuit 1B become non-conductive, the inter-electrode voltage Vg drops rapidly, the discharge current Is (preliminary discharge current Ib) drops sharply, and the arc is extinguished. In this case, at time t13 when the discharge current Is stops flowing, the pulse generation circuit 44 starts measuring the off time Of of the set machining condition. Then, at time t14 after the off time Of has elapsed, the second gate signal Agate is output again to turn on the switching element 22 of the auxiliary power supply circuit 1B, thereby starting the next electric discharge.

Although some specific examples have been illustrated for the machining power supply device of the embodiment described above, it is possible to make various modifications without being limited to the same configuration as the embodiment as long as the modifications do not contradict the technical idea of the disclosure.

### INDUSTRIAL APPLICABILITY

The disclosure can be used for metal machining. In particular, the machining power supply device of the disclosure is useful for wire cutting.

What is claimed is:

1. A wire electric discharge machine, comprising:
an auxiliary power supply circuit supplying a preliminary discharge current by applying a voltage for inducing generation of electric discharge to a machining gap formed by a wire electrode and a workpiece;
a main power supply circuit supplying a main discharge current to the machining gap;
a current detector detecting a discharge current flowing between the machining gap and a pair of conductors that are respectively provided above and below the workpiece and supply the discharge current to the wire electrode; and
a discharge position calculation circuit calculating a discharge position respectively from the preliminary discharge current detected through the current detector during a first period from a time when a waveform of the preliminary discharge current supplied to the machining gap rises to a time when the preliminary discharge current reaches a constant current value, and a second period after the time when the preliminary discharge current reaches the constant current value to a time when the main discharge current is supplied.

2. The wire electric discharge machine according to claim 1, wherein the current detector comprises a sensor detecting the preliminary discharge current flowing through the machining gap due to application of the voltage of the auxiliary power supply circuit via an upper conductor, and a sensor detecting the preliminary discharge current flowing through the machining gap due to application of the voltage of the auxiliary power supply circuit via a lower conductor, and
the discharge position calculation circuit acquires the preliminary discharge current from each of the sensors, calculates an integrated value of the preliminary discharge current to obtain each area, and obtains a ratio of the area to calculate the discharge position.

3. The wire electric discharge machine according to claim 1, further comprising a concentrated electric discharge detection circuit, wherein the concentrated electric discharge detection circuit determines concentrated electric discharge from the discharge position calculated in the first period.

4. The wire electric discharge machine according to claim 3, wherein the wire electric discharge machine stops supply of the main discharge current from the main power supply circuit to the wire electrode in response to the concentrated electric discharge detection circuit determining concentrated electric discharge.

5. The wire electric discharge machine according to claim 1, wherein the wire electric discharge machine calculates a plate thickness from the discharge position calculated during the second period.

6. The wire electric discharge machine according to claim 1, further comprising a partial electric discharge detection circuit, wherein the partial electric discharge detection circuit estimates a shape of a machined surface of the workpiece from the discharge position calculated in the second period, and determines that electric discharge is partially biased.

7. A wire electric discharge machining method, comprising:
supplying a preliminary discharge current by applying a voltage for inducing generation of electric discharge to a machining gap between a workpiece and a wire electrode;
supplying a main discharge current to the machining gap; and
detecting a discharge position respectively from a current value of the preliminary discharge current during a first period from a time when a waveform of the preliminary discharge current supplied to the machining gap rises to a time when the preliminary discharge current reaches a constant current value, and a second period after the time when the preliminary discharge current reaches the constant current value to a time when the main discharge current is supplied.

8. The wire electric discharge machining method according to claim 7, wherein detecting the discharge position comprises: acquiring the preliminary discharge current from a sensor detecting the preliminary discharge current flowing through the machining gap via an upper conductor and a sensor detecting the preliminary discharge current flowing through the machining gap via a lower conductor, calculating an integrated value of the preliminary discharge current to obtain each area, and obtaining a ratio of the area to calculate the discharge position.

9. The wire electric discharge machining method according to claim 7, further comprising determining concentrated electric discharge from the discharge position calculated in the first period.

10. The wire electric discharge machining method according to claim 9, comprising stopping supply of the main discharge current to the wire electrode in response to determining concentrated electric discharge.

11. The wire electric discharge machining method according to claim 7, comprising calculating a plate thickness from the discharge position calculated during the second period.

12. The wire electric discharge machining method according to claim 7, further comprising estimating a shape of a machined surface of the workpiece from the discharge position calculated in the second period, and determining that electric discharge is partially biased.
